(19) United States
(12) Patent Application Publication
(10) Pub. No.: US 2006/0291406 A1
(43) Pub. Date: Dec. 28, 2006

(54) Device authentication method and system

(75) Inventors: James Ronald Booth, Nicholasville, KY (US); John Francis Gostomski, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/166,935

(22) Filed: Jun. 23, 2005

(51) Int. Cl. H04B 3/20

(52) U.S. Cl. 370/289; 713/150

(57) ABSTRACT

A method and computer program product for selecting a secret value from a plurality of secret values, thus defining a chosen secret value. The chosen secret value is combined with a data value to generate a primary hybrid data value. The primary hybrid data value is processed to generate a processed primary hybrid data value, which is provided to a secondary device for authentication.

### TECHNICAL FIELD

This disclosure relates to device authentication and, more particularly, to printer cartridge authentication.

### BACKGROUND

Printing devices often use an electronic authentication procedure to determine if the printer cartridge installed in the printing device is an authentic printer cartridge (i.e., a printer cartridge that is allowed to be used within the printing device). Additionally, the electronic authentication procedure may determine what licensing privileges the cartridge is allowed.

The principal technique used in the electronic authentication procedure involves a “challenge” protocol in which a data set is provided to two “authentication engines”, the first being in the printer cartridge and the second being in the printing device. During authentication, both the printer cartridge and the printing device “seed” the data set with a “secret value” that is not revealed by the printer cartridge or the printing device. Typically, a one-way hash value of the “seeded data” is computed by the printer cartridge and the printing device. The printer cartridge then makes the one-way hash value available to the printing device, which compares the hash value (computed by the printer cartridge) to a hash value computed by the printing device. If the hash values match, the cartridge is authorized for use.

### SUMMARY OF THE DISCLOSURE

In one implementation, a method includes selecting a secret value from a plurality of secret values, thus defining a chosen secret value. The chosen secret value is combined with a data value to generate a primary hybrid data value. The primary hybrid data value is processed to generate a processed primary hybrid data value, which is provided to a secondary device for authentication.

One or more of the following features may also be included. The data value may include a constant value and a random value. The random value may be generated and may be provided to the secondary device. The random value may be processed to generate a modified random value. The chosen secret value, the constant value, and the modified random value may be combined to generate a primary modified hybrid data value. The primary modified hybrid data value may be processed to generate a processed primary modified hybrid data value. The processed primary modified hybrid data value may be compared to a processed secondary modified hybrid data value for authentication.

The secondary device may be a printer cartridge. The processing of the primary hybrid data value may include hashing the primary hybrid data value to generate the processed primary hybrid data value. A printing device may be monitored for the occurrence of a potential cartridge change event.

In another implementation, a method includes receiving a processed primary hybrid data value from a primary device. Each of a plurality of secret values are combined with a data value to generate a plurality of secondary hybrid data values. Each of the secondary hybrid data values is processed to generate a plurality of processed secondary hybrid data values. Each of the plurality of processed secondary hybrid data values is compared to the processed primary hybrid data value to determine a chosen secret value selected from the plurality of secret values.

One or more of the following features may also be included. The data value may include a constant value and a random value. The random value may be received from the primary device. The random value may be processed to generate a modified random value. The chosen secret value, the constant value, and the modified random value may be combined to generate a secondary modified hybrid data value. The secondary modified hybrid data value may be processed to generate a processed secondary modified hybrid data value. The processed secondary modified hybrid data value may be provided to the primary device for authentication. Processing the secondary modified hybrid data value may include hashing the secondary modified hybrid data value to generate the processed secondary modified hybrid data value.

The primary device may be a printing device. Processing each of the secondary hybrid data values may include hashing each of the secondary hybrid data values to generate the plurality of processed secondary hybrid data values.

In another implementation, a computer program product residing on a computer readable medium having a plurality of instructions stored on it. When executed by a processor, these instructions cause the processor to select a secret value from a plurality of secret values, thus defining a chosen secret value. The chosen secret value is combined with a data value to generate a primary hybrid data value. The primary hybrid data value is processed to generate a processed primary hybrid data value. The processed primary hybrid data value is provided to a secondary device for authentication.

One or more of the following features may also be included. The data value may include a constant value and a random value. The computer program product may include instructions for generating the random value, and providing the random value to the secondary device. The computer program product may include instructions for processing the random value to generate a modified random value.

The computer program product may include instructions for combining the chosen secret value, the constant value, and the modified random value to generate a primary modified hybrid data value; processing the primary modified hybrid data value to generate a processed primary modified hybrid data value; and comparing the processed primary modified hybrid data value to a processed secondary modified hybrid data value for authentication.

The secondary device may be a printer cartridge. The instructions for processing the primary hybrid data value may include instructions for hashing the primary hybrid data value to generate the processed primary hybrid data value. The computer program product may include instructions for monitoring a printing device for the occurrence of a potential cartridge change event.

In another implementation, a computer program product resides on a computer readable medium having a plurality of instructions stored on it. When executed by a processor, these instructions cause the processor to receive a processed primary hybrid data value from a primary device. Each of a plurality of secret values are combined with a data value to generate a plurality of secondary hybrid data values. Each of the secondary hybrid data values is processed to generate a plurality of processed secondary hybrid data values. Each of the plurality of processed secondary hybrid data values is compared to the processed primary hybrid data value to determine a chosen secret value selected from the plurality of secret values.

One or more of the following features may also be included. The data value may include a constant value and a random value. The computer program product may include instructions for receiving the random value from the primary device. The computer program product may include instructions for processing the random value to generate a modified random value.

The computer program product may include instructions for: combining the chosen secret value, the constant value, and the modified random value to generate a secondary modified hybrid data value; processing the secondary modified hybrid data value to generate a processed secondary modified hybrid data value; and providing the processed secondary modified hybrid data value to the primary device for authentication.

The instructions for processing the secondary modified hybrid data value may include instructions for hashing the secondary modified hybrid data value to generate the processed secondary modified hybrid data value. The primary device may be a printing device. The instructions for processing each of the secondary hybrid data values may include instructions for: hashing each of the secondary hybrid data values to generate the plurality of processed secondary hybrid data values.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printing device and a printer cartridge for use within the printing device;

FIG. 2 is a diagrammatic view of the printing device of FIG. 1 interfaced to the printer cartridge of FIG. 1;

FIG. 3 is a diagrammatic view illustrating the exchange of data between the printing device and printer cartridge of FIG. 1;

FIG. 4 is a flow chart of a process executed by the printing device of FIG. 1; and

FIG. 5 is a flow chart of a process executed by the printer cartridge of FIG. 1.

### DETAILED DESCRIPTION OF THE PREFERRED EMBODIMENTS

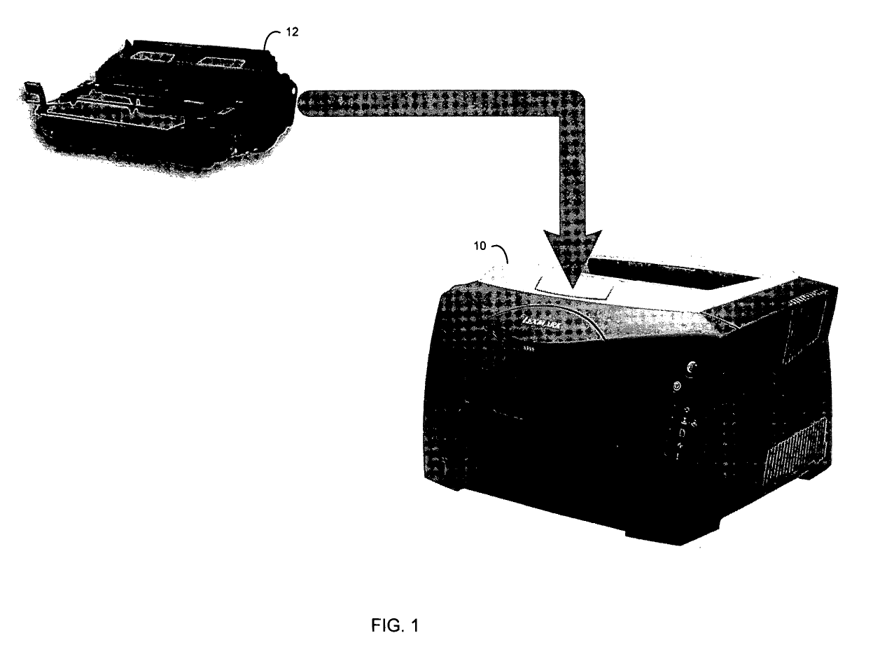

Referring to FIG. 1, there is shown a printing device 10 and a printer cartridge 12 for use within printing device 10. Printing device 10 may be coupled to a computing device (not shown) via e.g. a parallel printer cable (not shown) or a universal serial bus cable (not shown).

Printing device 10 is a device that may accept text and graphic information from a computing device and transfers the information to various forms of media (e.g., paper, cardstock, transparency sheets, etc.). Further a printer cartridge 12 may be a component of printing device 10, which typically includes the consumables/wear components (e.g. toner, a drum assembly, and a fuser assembly, for example) of printing device 10. Printer cartridge 12 typically also includes circuitry and electronics (not shown) required to e.g., charge the drum and control the operation of printer cartridge 12.

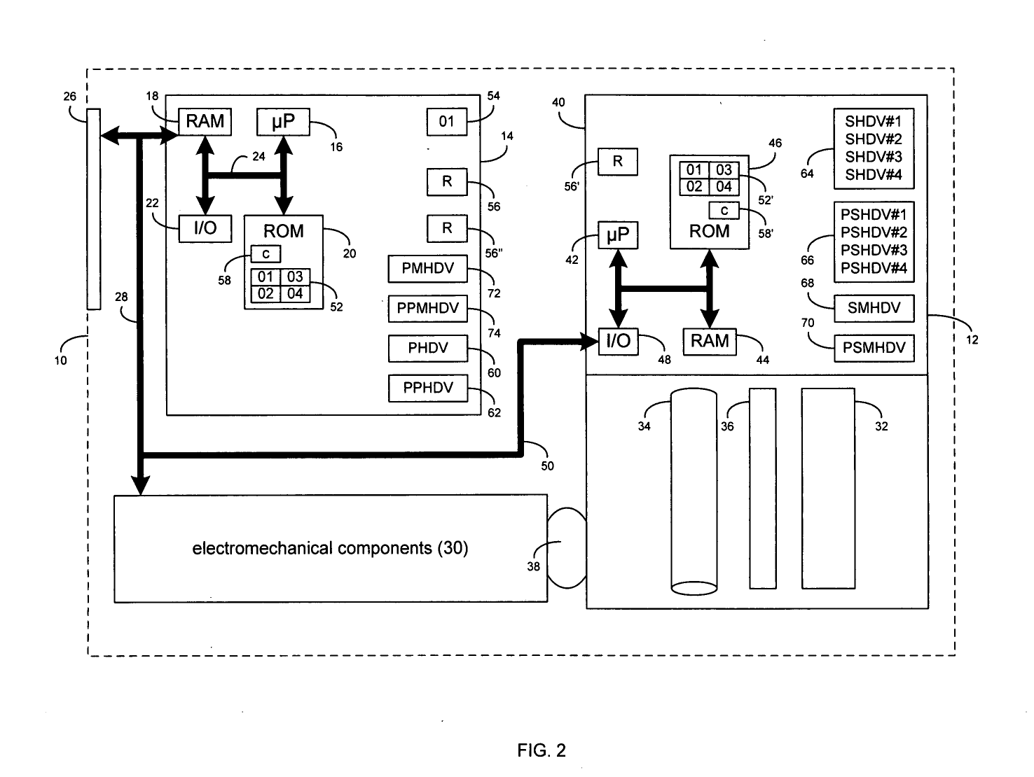

Referring also to FIG. 2, there is shown a diagrammatic view of printer cartridge 12 interfaced with printing device 10. Typically, printing device 10 includes a system board 14 for controlling the operation of printing device 10. System board 14 typically includes a microprocessor 16, random access memory (i.e., RAM) 18, read only memory (i.e., ROM) 20, and an input/output (i.e., I/O) controller 22. Microprocessor 16, RAM 18, ROM 20, and I/O controller 22 are typically coupled to each other via data bus 24. Examples of data bus 24 may include a PCI (i.e., Peripheral Component Interconnect) bus, an ISA (i.e., Industry Standard Architecture) bus, or a proprietary bus, for example.

Printing device 10 may include display panel 26 for providing information to a user (not shown). Display panel 26 may include e.g. an LCD (i.e. liquid crystal display) panel, one or more LEDs (i.e., light emitting diodes), and one or more switches. Typically, display panel 26 is coupled to I/O controller 22 of system board 14 via data bus 28. Examples of data bus 28 may include a PCI (i.e., Peripheral Component Interconnect) bus, an ISA (i.e., Industry Standard Architecture) bus, or a proprietary bus, for example. Printing device 10 typically also includes electromechanical components 30, such as: feed motors (not shown), gear drive assemblies (not shown), paper jam sensors (not shown), and paper feed guides (not shown), for example. Electromechanical components 30 may be coupled to system board 14 via data bus 28 and I/O controller 22.

As discussed above, printer cartridge 12 may include a toner reservoir 32, toner drum assembly 34, and fuser assembly 36, for example. Typically, electromechanical components 30 are mechanically coupled to printer cartridge 12 via a releasable gear assembly 38 that allows printer cartridge 12 to be removed from printing device 10.

Printer cartridge 12 typically includes a system board 40 that controls the operation of printer cartridge 12. System board 40 may include microprocessor 42, RAM 44, ROM 46, and I/O controller 48, for example. Typically, system board 40 is releasably coupled to system board 14 via data bus 50, thus allowing for the removal of printer cartridge 12 from printing device 10. Examples of data bus 50 may include a PCI (i.e., Peripheral Component Interconnect) bus, an ISA (i.e., Industry Standard Architecture) bus, or a proprietary bus.

Typically, only an authorized printer cartridge is permitted to be used within printing device 10. Accordingly, microprocessor 16 (i.e., on system board 14) and microprocessor 42 (i.e., on system board 40) each execute their respective portions of an authentication process that authenticates a printer cartridge for use in printing device 10. Once authenticated, a printer cartridge (e.g., printer cartridge 12) may be used within printing device 10.

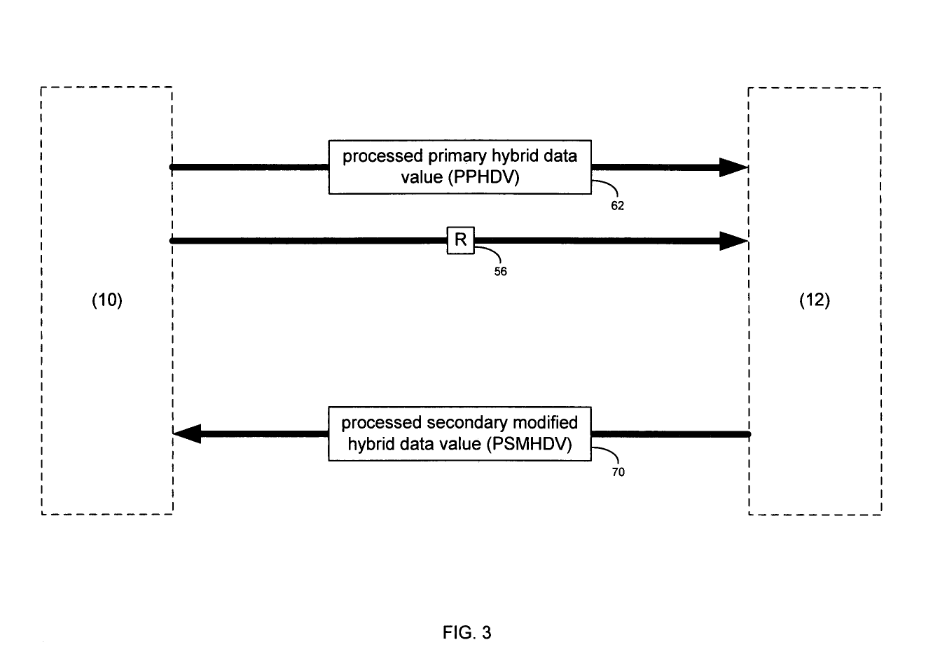

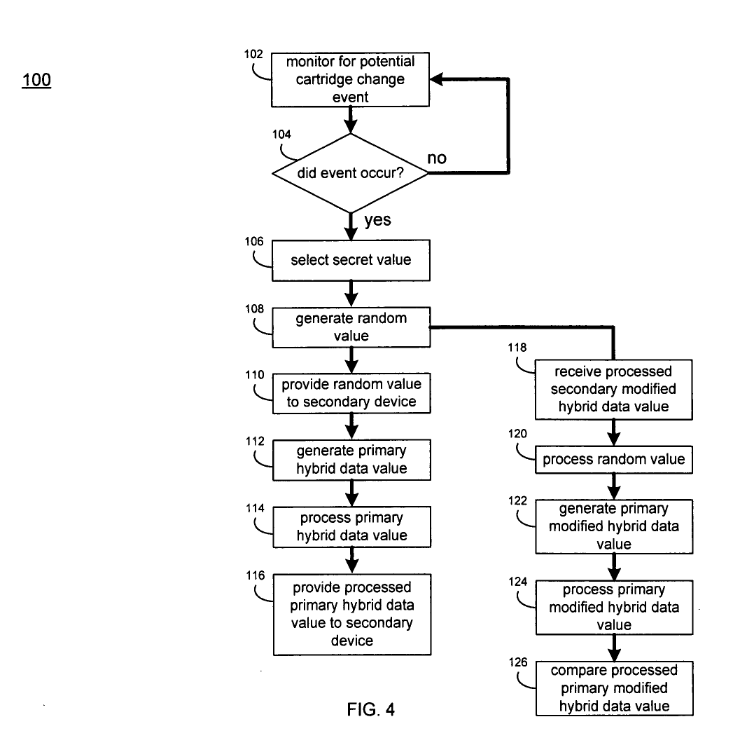

Referring also to FIGS. 3 and 4, FIG. 3 illustrates the sharing of data between printing device 10 and printer cartridge 12, while FIG. 4 illustrates an authentication process 100 executed by microprocessor 16 of system board 14. The instruction sets and subroutines of process 100 are typically stored on a storage device (e.g., ROM 20) and executed by microprocessor 16 using RAM 18. Other examples of the storage device include a hard disk drive or an optical drive, for example.

Process 100 monitors 102 printing device 10 for the occurrence of a potential cartridge change event (i.e., an event that may be indicative of a printer cartridge having been changed). Examples of a potential cartridge change event include the powering-up/resetting of printing device 10, or the opening of an access panel (not shown) on printing device 10.

If 104 a potential cartridge change event is detected, a secret value is selected 106 from a plurality of secret values 52 stored within ROM 20 of system board 14, thus defining a chosen secret value. Typically, this plurality of secret values 52 is defined and stored within printing device 10 at the time printing device 10 is manufactured. Accordingly, the plurality of secret values 52 may not be redefined thereafter, and are typically not accessible by a user (not shown) of printing device 10.

While plurality of secret values 52 is shown to include four secret values (namely 01, 02, 03 and 04), this is for illustrative purposes only and is not intended to limit this disclosure. Typically, each of the secret values is a 64-bit binary number.

Once a secret value (i.e., secret value 54) is selected 106 from the plurality of secret values 52, process 100 generates 108 a random value 56 using a random value generation process (not shown). Typically, random value 56 is a 128-bit binary number. Once generated, random value 54 is provided 110 (via data bus 50) to system board 40 of printer cartridge 12.

For the following example, assume that the secret value 54 (selected by process 100) is secret value “01”. Process 100 combines 112 secret value 54 with random value 56 and a constant value 58 to generate a primary hybrid data value (i.e., PHDV) 60. Constant value 58, which is typically a 320-bit number, is typically stored within ROM 20 of system board 14. An example of constant value 58 is three-hundred-twenty zeros or three-hundred-twenty ones. Constant value 58 is typically defined and stored within printing device 10 at the time printing device 10 is manufactured. Accordingly, constant value 58 may not be redefined thereafter, and is typically not accessible by a user (not shown) of printing device 10.

Once secret value 54, random value 56, and constant value 58 are combined 112, PHDV is generated. The PHDV is then processed 114 to generate a processed primary hybrid data value (i.e., a PPHDV) 62, which is then provided 116 to printer cartridge 12 for processing and authentication.

Typically, when processing 114 the PHDV, process 100 performs a hash function of the PHDV to generate the PPHDV. A Hashing function typically transforms a string of characters into a shorter fixed-length value that represents the original character string. For example, while the original character string (i.e., the PHDV) is 512-bits longs (i.e., the sum of the 320-bit constant value 58, the 64-bit secret value 54, and the 128-bit random value 56), the resulting hash (i.e., the PPHDV) is only 160-bits long.

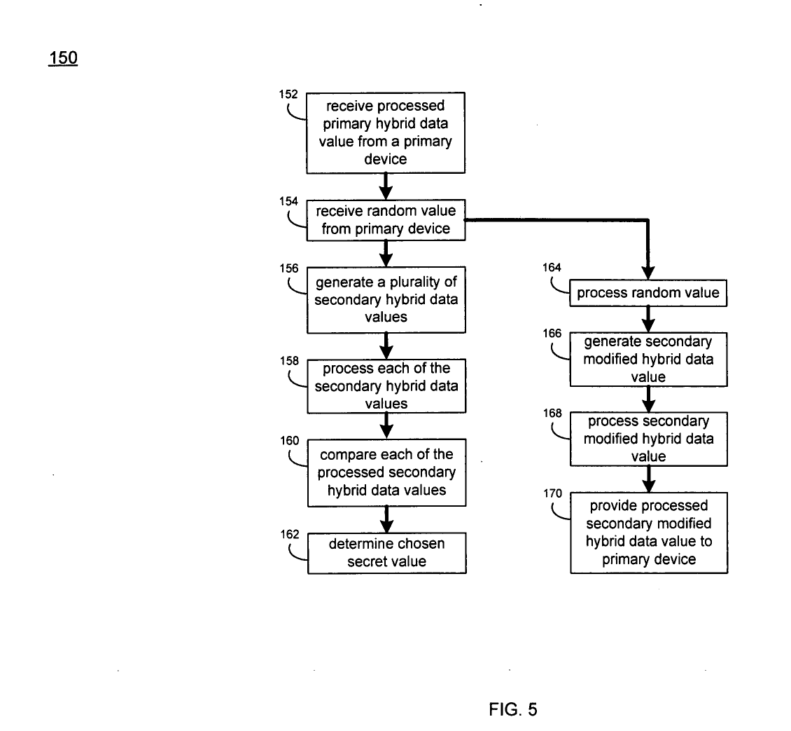

Referring also to FIG. 5, there is shown an authentication process 150 executed by microprocessor 42 of system board 40. The instruction sets and subroutines of process 150 are typically stored on a storage device (e.g., ROM 46) and executed by microprocessor 42 using RAM 44. Other examples of the storage device include a hard disk drive or an optical drive, for example.

As discussed above, process 100 provides 116 PPHDV 62 to printer cartridge 12 for processing and authentication. Accordingly, process 150 receives 152 PPHDV 62 from printing device 10. Further and as discussed above, process 100 provides 110 random value 56 to printer cartridge 12. Accordingly, process 150 receives 154 random value 56 from printing device 10.

As discussed above, a plurality of secret values 52 are defined and stored within printing device 10 at the time printing device 10 is manufactured. Additionally, printer cartridge 12 includes the same plurality of secret values 52′ (namely values 01, 02, 03 and 04) that are included within printing device 10.

Typically, this plurality of secret values 52′ is defined and stored within ROM 46 of printer cartridge 12 at the time printer cartridge 12 is manufactured. Accordingly, the plurality of secret values 52′ may not be redefined thereafter, and are typically not accessible by a user (not shown) of printer cartridge 12.

While plurality of secret values 52′ is shown to include four secret values (namely 01, 02, 03 and 04), this is for illustrative purposes only and is not intended to limit this disclosure.

As discussed above, a constant value 58 is defined and stored within printing device 10 at the time printing device 10 is manufactured. Additionally, printer cartridge 12 includes the same constant value 58′ that is included within printing device 10.

Typically, constant value 58′, which is typically a 320-bit number, is defined and stored within ROM 46 of printer cartridge 12 at the time printer cartridge 12 is manufactured. Accordingly, constant value 58′ may not be redefined thereafter, and is typically not accessible by a user (not shown) of printer cartridge 12.

Process 150 combines 156 random value 56 and constant value 58′ with each of the plurality of secret values 52′ generate a plurality of secondary hybrid data values (i.e., SHDVs) 64. Each SHDV is then processed 158 to generate a plurality of processed secondary hybrid data value (i.e., PSHDVs) 66, each of which is then compared 160 to the PPHDV 62 received 152 from printing device 10. Typically, when processing 158 each SHDV, process 150 performs a hash function (i.e., identical to the hash function performed by process 100) of each SHDV to generate each PSHDV.

As discussed above, printing device 10 and printer cartridge 12 each contain the same plurality of secret values, namely plurality of secret values 52 on printing device 10 and plurality of secret values 52′ on printer cartridge 12. Additionally, printing device 10 and printer cartridge 12 each contain the same constant value (i.e., constant value 58 on printing device 10 and constant value 58′ on printer cartridge 12). Further, printing device 10 and printer cartridge 12 each use random value 56 when calculating PHDV 60 and each of the plurality of SHDVs 64 respectively. Accordingly, one of the plurality of PSHDVs 66 (generated by printer cartridge 12) must match the PPHDV 62 (generated by printing device 10), as both devices 10, 12 use a common hashing function (as discussed above).

Process 150 compares each of the plurality of PSHDVs 66 (generated by printer cartridge 12) to the PPHDV 62 (generated by printing device 10) to determine which of the plurality of PSHDVs 66 matches the PPHDV 62.

Continuing with the above-stated example, secret value 54 (as selected by process 100) is secret value “01”. Accordingly, PSHDV#1 (from plurality of PSHDVs 66) will match PPHDV 62, as they were both generated using secret value “01”. Accordingly, process 150 determined 162 that secret value “01” was chosen by process 100.

Process 150 processes 164 (in a manner known to both printing device 10 and printer cartridge 12) random value 56 to generate modified random value 56′. Examples of the type of processing 164 performed on random value 56 include taking the two's compliment, flipping the first bit, and flipping the last bit. Assume for this example, when processing 164 random value 56, process 150 changes the last bit of random value 56 to generate modified random value 56′.

Once modified random value 56′ is generated, process 150 combine 166 modified random value 56′ and constant value 58′ with the secret value chosen by process 100 (i.e., secret value “01” in this example) to generate a secondary modified hybrid data value (i.e., SMHDV) 68. SMHDV 68 is then processed 168 to generate a processed secondary modified hybrid data value (i.e., PSMHDV) 70, which is provided 170 to printing device 10. Typically, when processing 168 SMHDV 68, process 150 performs a hash function (i.e., identical to the hash function performed by process 100) of SMHDV 68 to generate PSMHDV 70.

Referring again to FIG. 4, process 100 receives 118 PSMHDV 70 from printer cartridge 12. Process 100 processes 120 random value 56 to generate modified random value 56″. The manner in which random value 56 is processed 120 (by process 100) to generate modified random value 56″ is identical to the manner in which random value 56 is processed 164 (by process 150) to generate modified random value 56′. Examples of the type of processing 120 performed on random value 56 (to generate modified random value 56″) include taking the two's compliment, flipping the first bit, and flipping the last bit. As discussed above, assume for this example that when processing 120 random value 56 (to generate modified random value 56″), process 100 changes the last bit of random value 56 to generate modified random value 56″. Accordingly, as process 100 and process 150 use identical processes to convert random value 56 to modified random values 56″, 56′ respectively, modified random values 56″ and 56′ are identical.

Once modified random value 56″ is generated, process 150 combines 122 modified random value 56″ and constant value 58 with the secret value chosen by process 100 (i.e., secret value “01” in this example) to generate a primary modified hybrid data value (i.e., PMHDV) 72. PMHDV 72 is then processed 124 to generate a processed primary modified hybrid data value (i.e., PPMHDV) 74. PPMHDV 74 is then compared 126 to PSMHDV 70 (previously received 118 from printer cartridge 12).

If PPMHDV 74 matches PSMHDV 70, printer cartridge 12 is an authorized printer cartridge and, therefore, will function properly in printing device 10. However, in the event that PPMHDV 74 does not match PSMHDV 70, printer cartridge 12 is an unauthorized printer cartridge and, therefore, printing device 10 will be prohibited from functioning until the unauthorized printer cartridge is removed and replaced with an authorized printer cartridge.

A number of implementations have been described. Nevertheless, it will be understood that various modifications may be made. Accordingly, other implementations are within the scope of the following claims.

What is claimed is:

1. A method comprising:
selecting a secret value from a plurality of secret values, thus defining a chosen secret value;
combining the chosen secret value with a data value to generate a primary hybrid data value;
processing the primary hybrid data value to generate a processed primary hybrid data value; and
providing the processed primary hybrid data value to a secondary device for authentication.

2. The method of claim 1 wherein the data value includes a constant value and a random value, the method further comprising:
generating the random value; and
providing the random value to the secondary device.

3. The method of claim 2 further comprising:
processing the random value to generate a modified random value.

4. The method of claim 3 further comprising:
combining the chosen secret value, the constant value, and the modified random value to generate a primary modified hybrid data value;
processing the primary modified hybrid data value to generate a processed primary modified hybrid data value; and
comparing the processed primary modified hybrid data value to a processed secondary modified hybrid data value for authentication.

5. The method of claim 1 wherein the secondary device is a printer cartridge.

6. The method of claim 1 wherein processing the primary hybrid data value includes:
hashing the primary hybrid data value to generate the processed primary hybrid data value.

7. The method of claim 1 further comprising:
monitoring a printing device for the occurrence of a potential cartridge change event.

8. A method comprising:
receiving a processed primary hybrid data value from a primary device;
combining each of a plurality of secret values with a data value to generate a plurality of secondary hybrid data values;
processing each of the secondary hybrid data values to generate a plurality of processed secondary hybrid data values; and
comparing each of the plurality of processed secondary hybrid data values to the processed primary hybrid data value to determine a chosen secret value selected from the plurality of secret values.

9. The method of claim 8 wherein the data value includes a constant value and a random value, the method further comprising:
receiving the random value from the primary device.

10. The method of claim 9 further comprising:
processing the random value to generate a modified random value.

11. The method of claim 10 further comprising:
combining the chosen secret value, the constant value, and the modified random value to generate a secondary modified hybrid data value;
processing the secondary modified hybrid data value to generate a processed secondary modified hybrid data value; and
providing the processed secondary modified hybrid data value to the primary device for authentication.

12. The method of claim 11 wherein processing the secondary modified hybrid data value includes:
hashing the secondary modified hybrid data value to generate the processed secondary modified hybrid data value.

13. The method of claim 8 wherein the primary device is a printing device.

14. The method of claim 8 wherein processing each of the secondary hybrid data values includes:
hashing each of the secondary hybrid data values to generate the plurality of processed secondary hybrid data values.

15. A computer program product residing on a computer readable medium having a plurality of instructions stored thereon which, when executed by a processor, cause the processor to:
select a secret value from a plurality of secret values, thus defining a chosen secret value;
combine the chosen secret value with a data value to generate a primary hybrid data value;
process the primary hybrid data value to generate a processed primary hybrid data value; and
provide the processed primary hybrid data value to a secondary device for authentication.

16. The computer program product of claim 15 wherein the data value includes a constant value and a random value, the computer program product further comprising instructions for:
generating the random value; and
providing the random value to the secondary device.

17. The computer program product of claim 16 further comprising instructions for:
processing the random value to generate a modified random value.

18. The computer program product of claim 17 further comprising instructions for:
combining the chosen secret value, the constant value, and the modified random value to generate a primary modified hybrid data value;
processing the primary modified hybrid data value to generate a processed primary modified hybrid data value; and
comparing the processed primary modified hybrid data value to a processed secondary modified hybrid data value for authentication.

19. The computer program product of claim 15 wherein the secondary device is a printer cartridge.

20. The computer program product of claim 15 wherein the instructions for processing the primary hybrid data value include instructions for:
hashing the primary hybrid data value to generate the processed primary hybrid data value.

21. The computer program product of claim 15 further comprising instructions for:
monitoring a printing device for the occurrence of a potential cartridge change event.

22. A computer program product residing on a computer readable medium having a plurality of instructions stored thereon which, when executed by a processor, cause the processor to:
receive a processed primary hybrid data value from a primary device;
combine each of a plurality of secret values with a data value to generate a plurality of secondary hybrid data values;
process each of the secondary hybrid data values to generate a plurality of processed secondary hybrid data values; and
compare each of the plurality of processed secondary hybrid data values 10 to the processed primary hybrid data value to determine a chosen secret value selected from the plurality of secret values.

23. The computer program product of claim 22 wherein the data value includes a constant value and a random value, the computer program product further comprising instructions for:
receiving the random value from the primary device.

24. The computer program product of claim 23 further comprising instructions for:
processing the random value to generate a modified random value.

25. The computer program product of claim 24 further comprising instructions for:
combining the chosen secret value, the constant value, and the modified random value to generate a secondary modified hybrid data value;
processing the secondary modified hybrid data value to generate a processed secondary modified hybrid data value; and
providing the processed secondary modified hybrid data value to the primary device for authentication.

26. The computer program product of claim 25 wherein the instructions for processing the secondary modified hybrid data value include instructions for:
hashing the secondary modified hybrid data value to generate the processed secondary modified hybrid data value.

27. The computer program product of claim 22 wherein the primary device is a printing device.

28. The computer program product of claim 22 wherein the instructions for processing each of the secondary hybrid data values include instructions for:
hashing each of the secondary hybrid data values to generate the plurality of processed secondary hybrid data values.
